(19) United States
(12) Patent Application Publication
(10) Pub. No.: US 2010/0125814 A1
(43) Pub. Date: May 20, 2010

(54) USER INTERFACE FOR A PROJECT MANAGEMENT SYSTEM

(76) Inventor: Kenneth R. Lemons, Indianapolis, IN (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 12/621,188

(22) Filed: Nov. 18, 2009

Related U.S. Application Data
(60) Provisional application No. 61/115,669, filed on Nov. 18, 2008.

(51) Int. Cl. G06F 3/048; G06Q 10/00

(52) U.S. Cl. 715/853; 705/9

(57) ABSTRACT

A user interface for a project management system is disclosed. The interface utilizes a circular format to convey various project task and entity relationships including hierarchical abstraction levels, relative priority, percent completion, and various other pertinent data. The system also provides the ability to quickly transverse through levels of abstraction or priority within a project or data set in a spatially efficient manner.

### CROSS-REFERENCE TO RELATED APPLICATIONS

The present application claims the benefit of U.S. Provisional Patent Application Ser. No. 61/115,669 filed Nov. 18, 2008 entitled “User Interface for a Project Management System” which is hereby incorporated by reference in its entirety.

### TECHNICAL FIELD OF THE INVENTION

The present disclosure relates generally to project management systems and, more particularly, to a user interface for a project management system.

### BACKGROUND OF THE INVENTION

Various methods are known in the art for organizing and managing tasks within a complex business project. Such methods are often implemented using software and provided as a packaged product suite or on-line application. These products are capable of organizing massive amounts of data and tracking virtually all aspects of a project. Various charts and graphs may be displayed which are intended to aid the user in understanding the status of each task required to complete the project.

One problem, however, is that as the amount of relevant project data increases, the displays produced by these products become correspondingly complex and may be difficult for the user to interpret. For example, a method commonly employed is to display each set of tasks as a series of bars on a page, with the length of each bar corresponding to the amount of time required to complete a task. This linear display is helpful from an accuracy or pure data standpoint, but requires the user to repeatedly move his or her eyes or “focus” around the page to view each task, making it harder to keep track of multiple tasks in his or her head.

Another option is to display the various tasks as a series of randomly spaced orbs on a page, with lines connecting each of the related tasks. While this approach may be more spatially efficient, its random nature is still confusing to the mind and eye of the user. In other words, the user still has to spend time visually searching the display to find a particular task or organizational item.

Because the human eye and brain can reasonably focus on only one task or item at a time, it is important to present data in a fashion that makes the most efficient use of the visual and comprehendible “real estate” within a display. An interface for displaying and manipulating project management data is therefore needed which is spatially efficient, yet contains all of the details required to fully inform the user. The present application fills that need.

### SUMMARY OF THE INVENTION

According to one aspect, a method for providing a visualization of task relationships within a project is disclosed, comprising the steps of: providing a first plurality of equally spaced shapes in the formation of a first ring on a display, each one of said first plurality of shapes representing a first plurality of corresponding tasks within said project; and concurrently providing a second plurality of equally spaced shapes in the formation of a second ring on the display, each one of said second plurality of shapes representing a second plurality of corresponding tasks within said project; wherein the relative priority of said first plurality of corresponding tasks is higher than the relative priority of said second plurality of corresponding tasks; and wherein the first ring has a first diameter which is smaller than a second diameter of the second ring.

According to another aspect, a system for visualizing task relationships within a project is disclosed, comprising: a user input device; a processing device operatively coupled to said user input device; and a display operatively coupled to said processing device; wherein: said processing device executes computer readable code to create a first visual representation of said task relationships for output on said display; wherein: said first visual representation is generated according to a method comprising the steps of: providing a first plurality of equally spaced shapes in the formation of a first ring on a display, each one of said first plurality of shapes representing a first plurality of corresponding tasks within said project; and concurrently providing a second plurality of equally spaced shapes in the formation of a second ring on the display, each one of said second plurality of shapes representing a second plurality of corresponding tasks within said project; wherein: the relative priority of said first plurality of corresponding tasks is higher than said the relative priority of said second plurality of corresponding tasks; and wherein: the first ring has a first diameter which is smaller than a second diameter of the second ring.

According to another aspect, a device is disclosed comprising a computer readable medium, said computer readable medium containing computer executable code for generating a visual representation of task relationships within a project; wherein: said computer executable code is configured to generate said visual representation according to a method comprising the steps of: providing a first plurality of equally spaced shapes in the formation of a first ring on a display, each one of said first plurality of shapes representing a first plurality of corresponding tasks within said project; and concurrently providing a second plurality of equally spaced shapes in the formation of a second ring on the display, each one of said second plurality of shapes representing a second plurality of corresponding tasks within said project; wherein: the relative priority of said first plurality of corresponding tasks is higher than said the relative priority of said second plurality of corresponding tasks; and wherein: the first ring has a first diameter which is smaller than a second diameter of the second ring.

In another aspect, a system for visualizing task relationships within a project, comprising: a user input device; a processing device operatively coupled to said user input device; and a display operatively coupled to said processing device; wherein: said processing device executes computer readable code to create a first visual representation of said task relationships for output on said display; wherein: said first visual representation is generated according to a method comprising the steps of: providing a first plurality of equally spaced shapes in the formation of a first ring on a display, each one of said first plurality of shapes representing a first plurality of corresponding parent tasks within said project; selecting a first one of said first plurality of equally spaced shapes corresponding to a first one of said parent tasks; and providing a second plurality of equally spaced shapes in the formation of a second ring on the display, each one of said second plurality of equally spaced shapes representing a second plurality of corresponding sub-tasks within said first one of said parent tasks.

### BRIEF DESCRIPTION OF THE DRAWINGS

FIGS. 1-6 are schematic views of displays generated for task groups containing one to six tasks respectively according to one embodiment.

FIG. 7 is a schematic view of a display generated for a project according to one embodiment.

FIG. 8 is a schematic view of the display from FIG. 7 after the user has added an additional task.

FIG. 9 is a schematic view of a display containing two sub-tasks within one of the parent tasks from FIG. 8 according to one embodiment.

FIG. 10 is a schematic list view of the display from FIG. 8 according to one embodiment.

FIG. 11 is a schematic view of a task layer having eight tasks according to one embodiment.

FIG. 12 is a schematic view of the display of FIG. 11 after the user has increased the priority of one of the tasks according to one embodiment.

FIG. 13 is a schematic view of a task relationship with two priority levels of tasks according to one embodiment.

FIG. 14 is a schematic view of the display of FIG. 13 after the user has increased the priority level of one of the higher priority tasks.

FIG. 15 is a schematic view of a task layer having additional percent completion indicators according to one embodiment.

FIG. 16 is a schematic view of a task relationship having two priority levels of tasks according to one embodiment.

FIG. 17 is a schematic view of the display of FIG. 16 after the user has selected a control which reduces the amount of displayed abstraction layers.

FIG. 18 is a schematic view of the display of FIG. 16 after the user has selected a control which increases the amount of displayed abstraction layers.

FIG. 19 is a schematic view of a display representing the relationships of individuals in an organization according to one embodiment.

FIG. 20 is a timeline view of a task percent completion according to one embodiment.

FIG. 21 is a schematic view of a system for displaying the relationship of task in a project according to one embodiment.

### DETAILED DESCRIPTION OF THE ILLUSTRATED EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended, and alterations and modifications in the illustrated device, and further applications of the principles of the invention as illustrated therein are herein contemplated as would normally occur to one skilled in the art to which the invention relates.

The present disclosure is generally directed to an interface which allows a user to view and manipulate project management data or tasks in a circularly efficient manner. A given list of tasks is displayed as a series of shapes along the perimeter of a larger ring (such as a circle or polygon), with various concentric rings used to indicate levels of relative priority. The interface may be used to convey the relationships of tasks within a project, the relationship of individuals within a company, the relationship of design elements within a complicated device, or virtually any other set of relationships that is important to the user. The interface may also be used to keep track of simpler tasks, such as a “to-do” list of personal items. The present disclosure contemplates that the interface may be provided as a hosted online application service, a stand-alone software application, or as an add-on module for a standard project management system, such as Microsoft Project®.

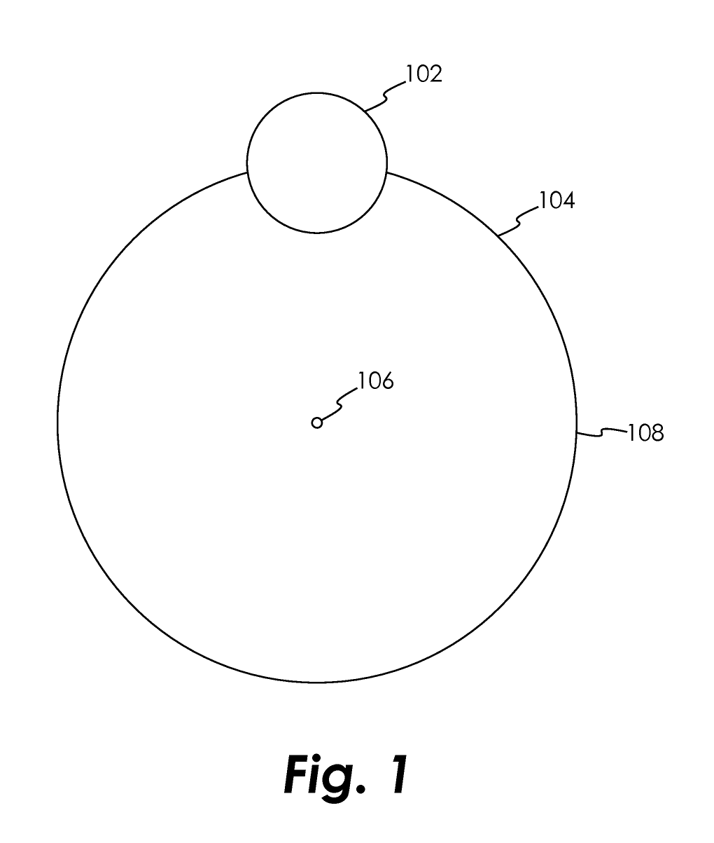

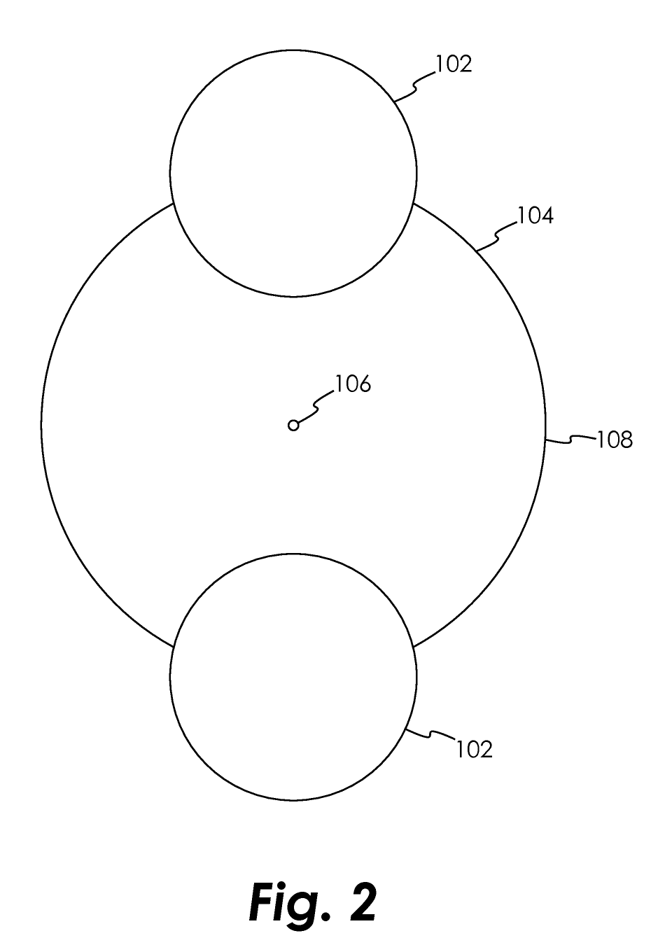

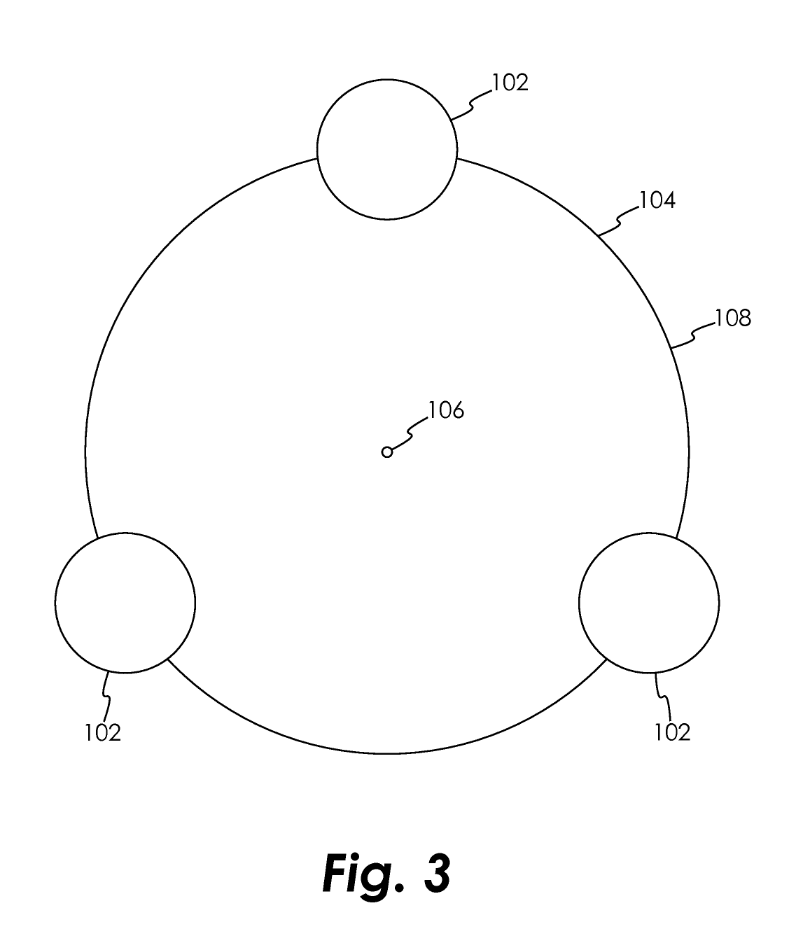

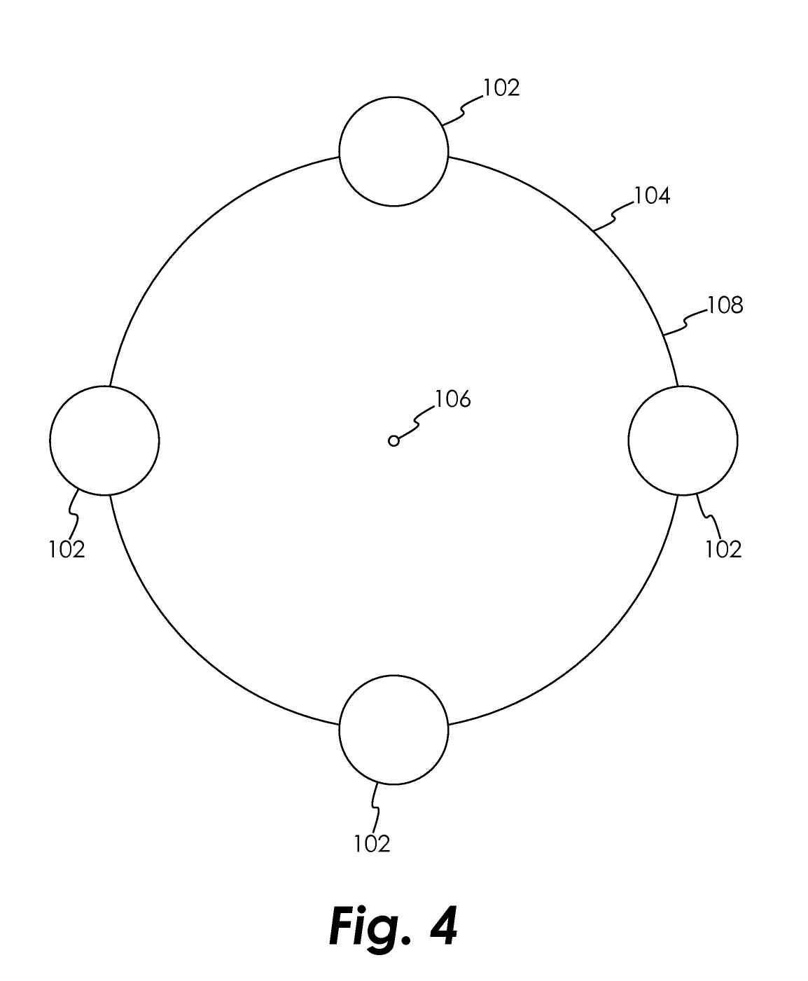

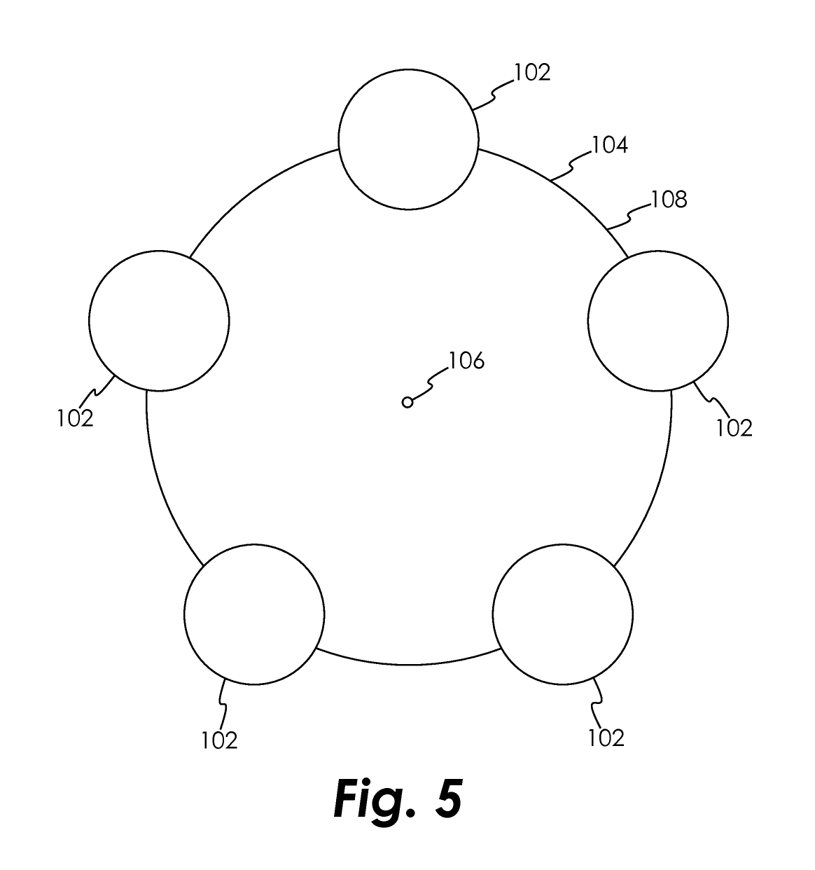

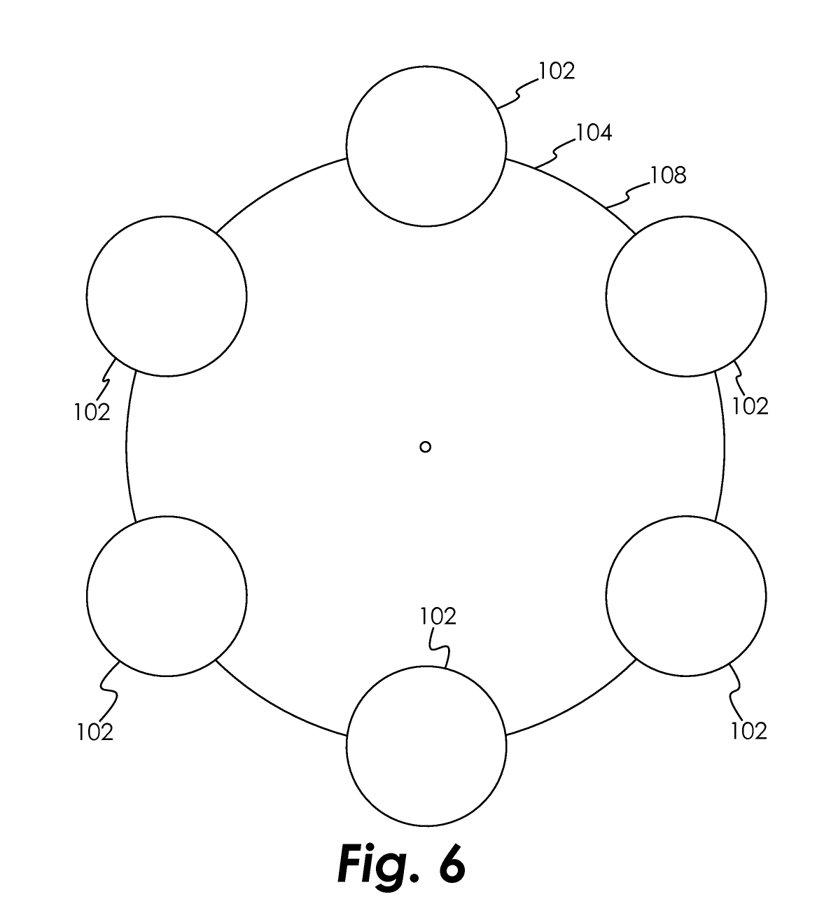

FIGS. 1-6 illustrate the basic shapes used to display task groups containing one to six tasks respectively according to one embodiment. Each task is represented by a task circle 102 within an orbit 104 (identified by line 108) about a center point 106. In one embodiment, the task circles 102 will be arranged such that a task circle 102 is always in the twelve o'clock position as shown. In addition to task circles 102, other shapes, such as rectangles and ellipses may be used to represent the individual tasks or items. Although up to six tasks are shown in the shapes illustrated in FIGS. 1-6, an unlimited number of task circles 102 may be displayed within the same shape or ringed layer. It shall also be understood that the lines 108 may be omitted in certain embodiments, with the task circles 102 still generally arranged about the center point 106 in a circular fashion. It shall be further understood that the lines 108 may be implemented as a curve as shown or as straight lines connecting the task circles 102, to name just a few non-limiting examples.

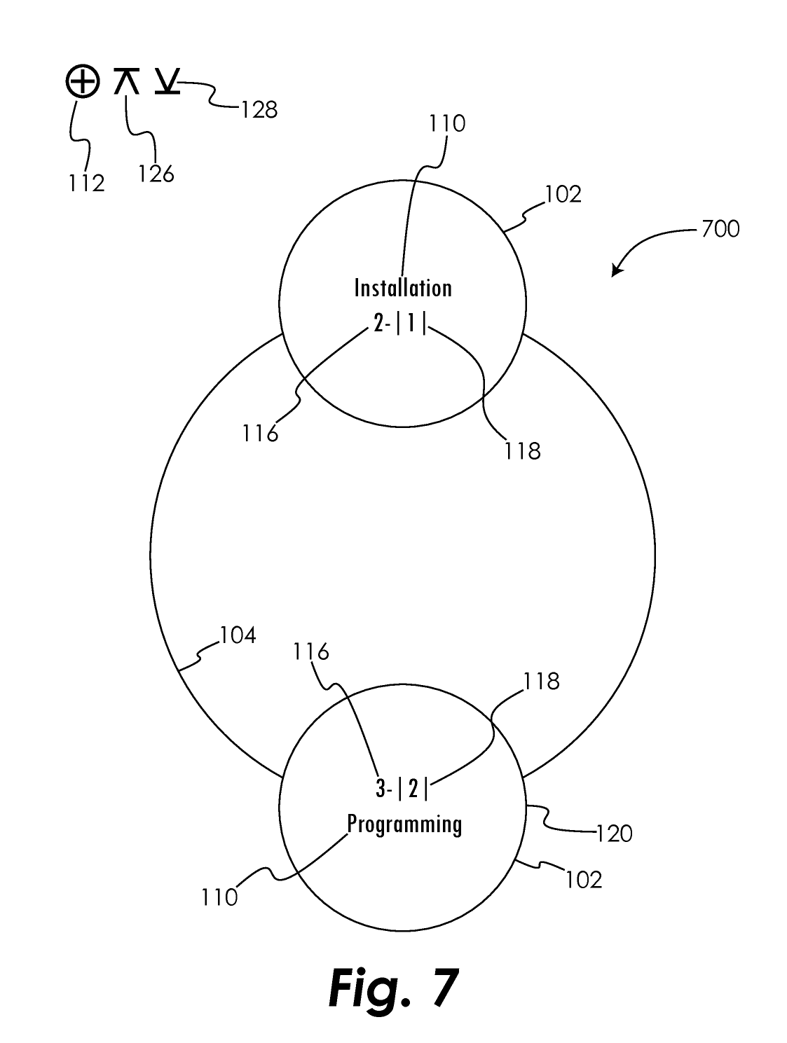

In certain embodiments, the user is able to build a task diagram in a static mode by adding individual tasks to a chosen orbit. FIG. 7 shows a display 700 which already contains two initial task circles 102 within an orbit 104. The task circles 102 are labeled with labels 110 to identify the represented task. The labels 110 may be placed within or otherwise close to (or linked to) the task circles 102. To add a task to the given grouping or orbit 104, the user clicks or otherwise selects an “Add Task” icon 112 located on the screen. The system will then prompt the user to enter information about the task, such as a task name, description, priority level, and assigned person. In certain embodiments, the system may optionally allow the user to attach or otherwise associate electronic files with the added task for later retrieval and inspection.

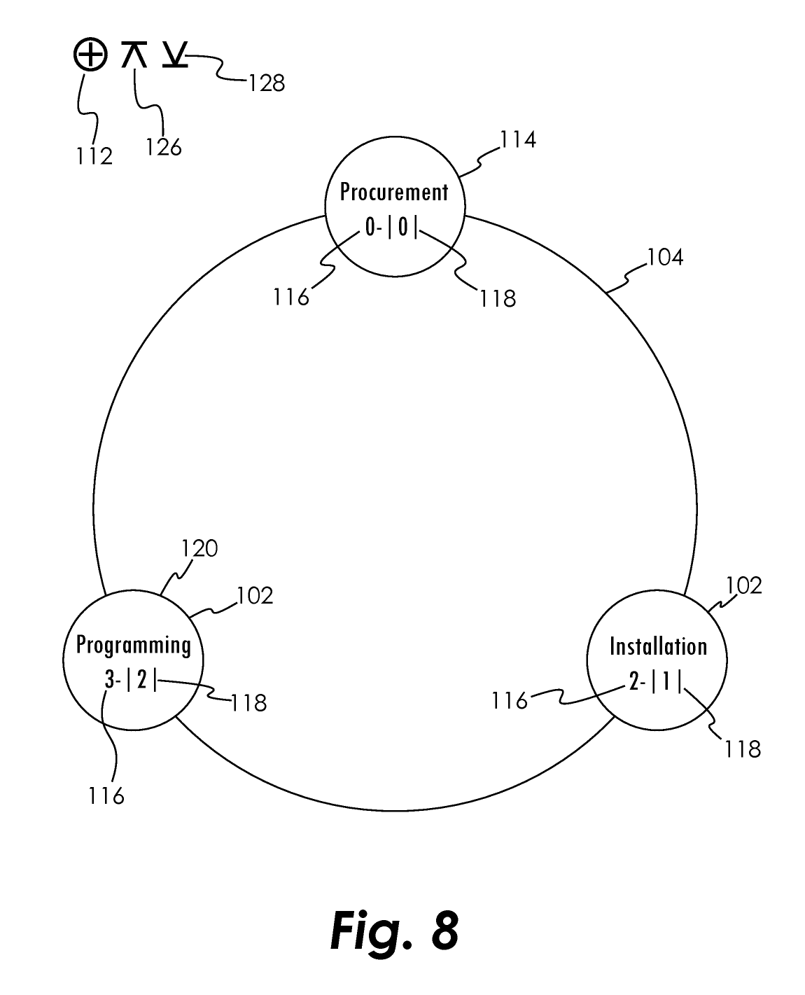

Once the information is entered and confirmed by the user, the display 700 will be adjusted to include the new task circle 114 within the orbit 104 as shown in FIG. 8. In certain embodiments, the new task circle 114 will be initially positioned at the twelve o'clock position of the orbit 104 to allow easy confirmation by the user when a large number of task circles 102 are being displayed.

In addition to upper level task groupings, sub-tasks may be contained within each upper level task to show additional granularity. As shown in FIGS. 7 and 8, an indicator 116 may be optionally displayed on each task circle 102 to identify the quantity of sub-tasks which are contained within the parent task. An additional indicator 118 may also be displayed which identifies the number of abstraction layers (sub-layers) which are contained within the parent task. For example, the “Programming” task represented by task circle 120 has three sub-tasks arranged within two sub-layers of complexity.

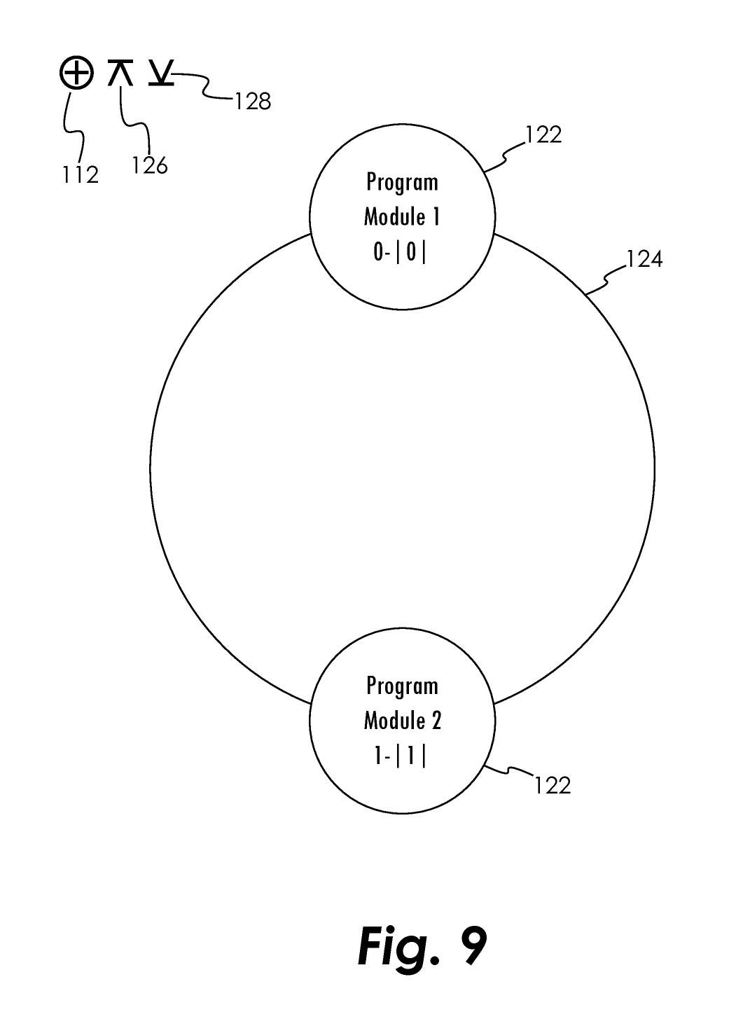

To view the next sub-layer of sub-tasks within a parent task, such as the “Programming” task circle 120, the user double clicks or otherwise selects the task circle 120. The system then displays the sub-tasks 122 within a new orbit 124 as shown in FIG. 9. To add a new sub-task, the user simply clicks the “add task” icon 112 as described above. Icons 126 and 128 may optionally be provided to allow the user to move up and down in levels of complexity as desired. For example, clicking the “up” indicator 126 in FIG. 9 will return to the display of FIG. 7, which shows the task layer containing the “Programming” task circle 120. Likewise, clicking the “down” indicator 128 will create a new display showing the next level of complexity within the currently selected task circle 122.

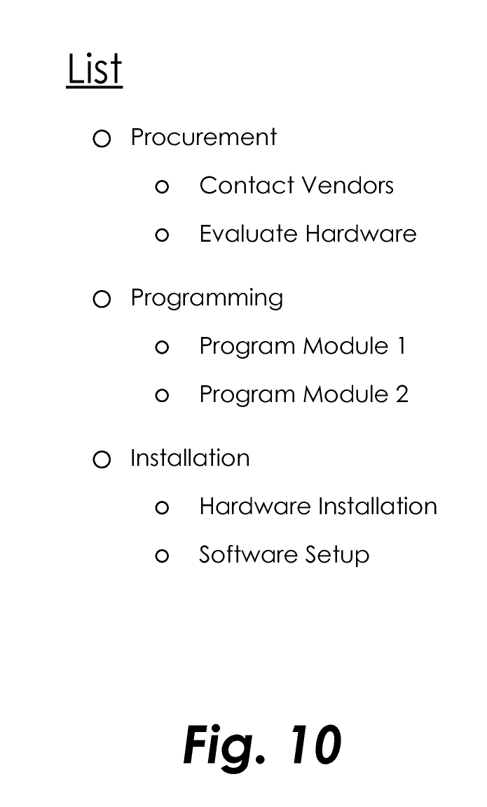

In certain embodiments, the system may optionally display a “list view” of all the sub-tasks within a task tree when selected by the user, as shown in FIG. 10. Using the list view, sub-tasks are indented below their corresponding parent tasks, for a quick linear reference, if desired. The system may also be configured such that the user may click on a task within the list view and be directed immediately to the particular task in the circular static view.

Once the task relationships have been established from a complexity or abstraction standpoint using the static mode, the user is then able to switch to a dynamic or “Hoop of Hoops™” mode in which multiple concentric orbits are displayed on a single screen. In one embodiment, the concentric orbital relationships can be used to convey the priority level of various tasks, with higher priority tasks displayed in increasingly inner orbits and lower priority tasks displayed in increasingly outer orbits in certain embodiments.

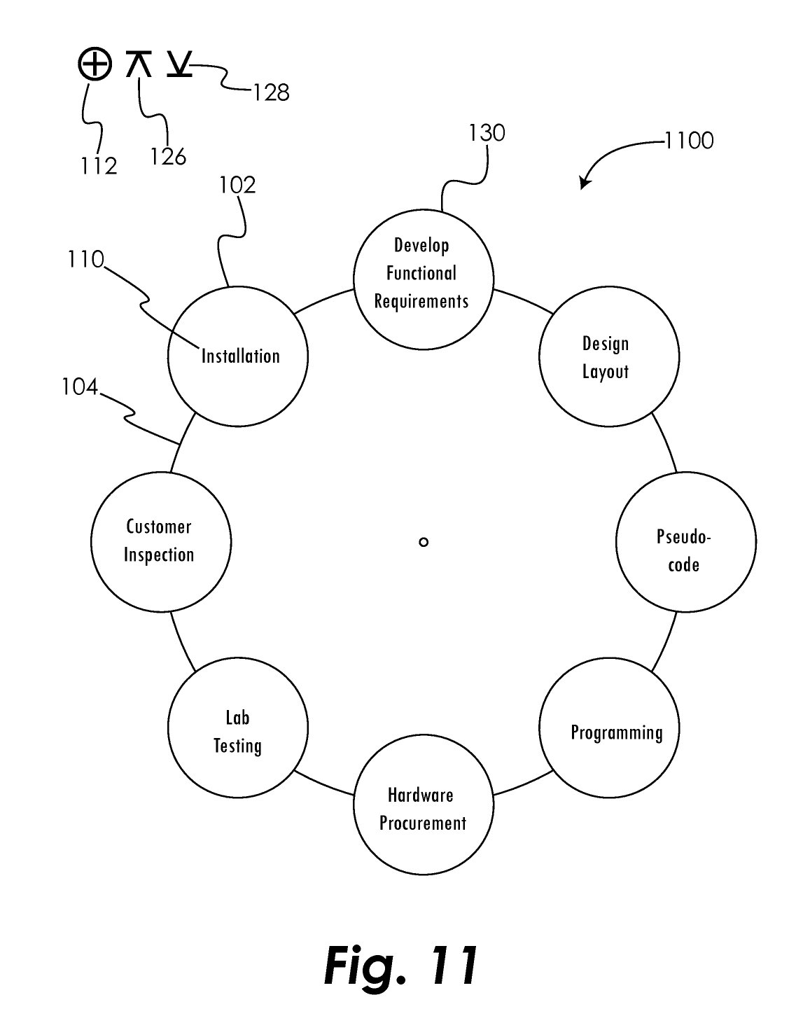

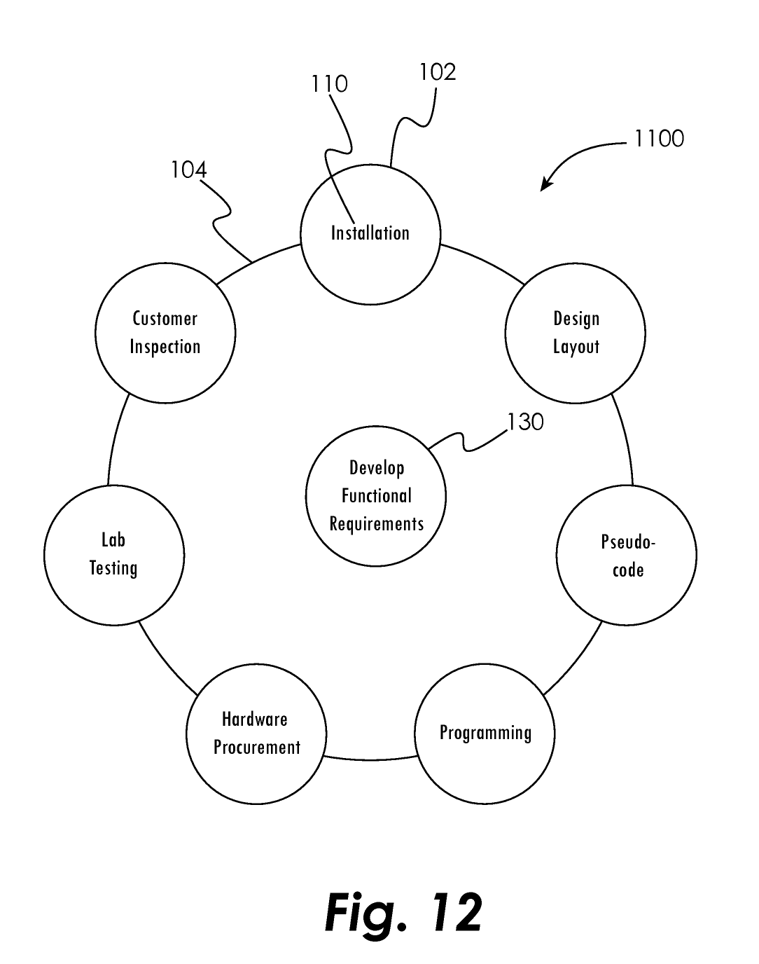

FIG. 11 depicts a display 1100 in dynamic mode where eight tasks have been initially given an equal priority by a user. Because the human brain can only focus on one task at a time, however, it may become difficult to keep track of the various task circles 102 as the number of task circles 102 becomes larger. Therefore, when a user wishes to examine or prioritize a particular task, the user may click on the corresponding task circle, such as task circle 130 representing the task “Develop Functional Requirements.” The system then moves the task circle 130 to the center of the display as shown in FIG. 12. In certain embodiments, the system may increase the size of a task circle 130 when that circle is selected in order to place visual emphasis on the circle 102 and allow more data to be easily displayed within the task circle 102, 130.

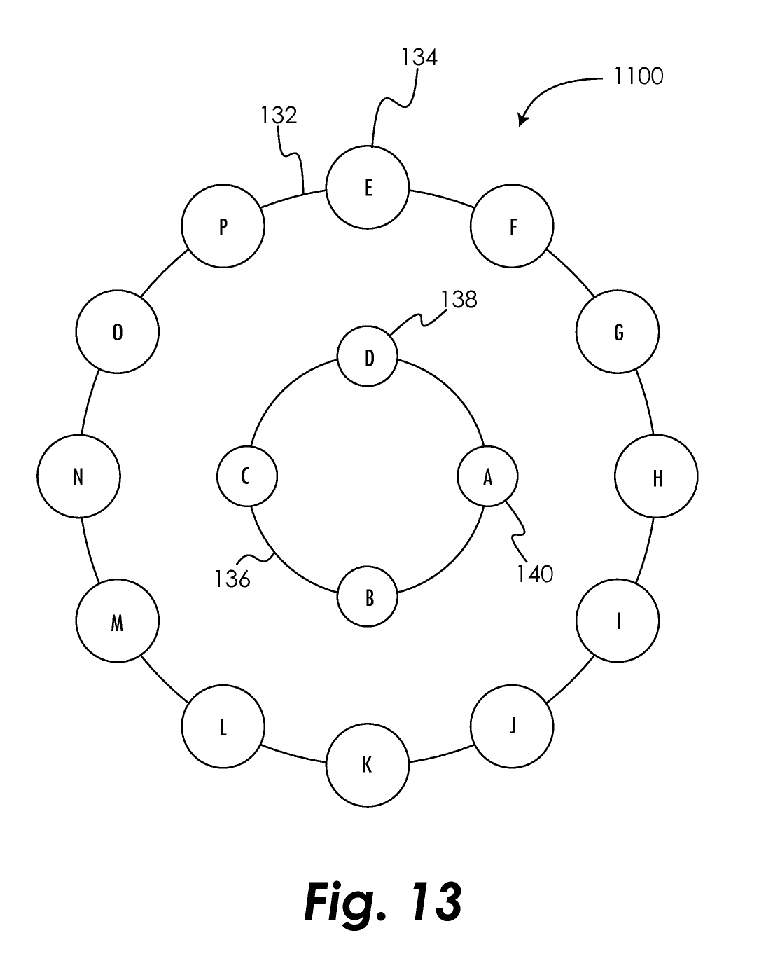

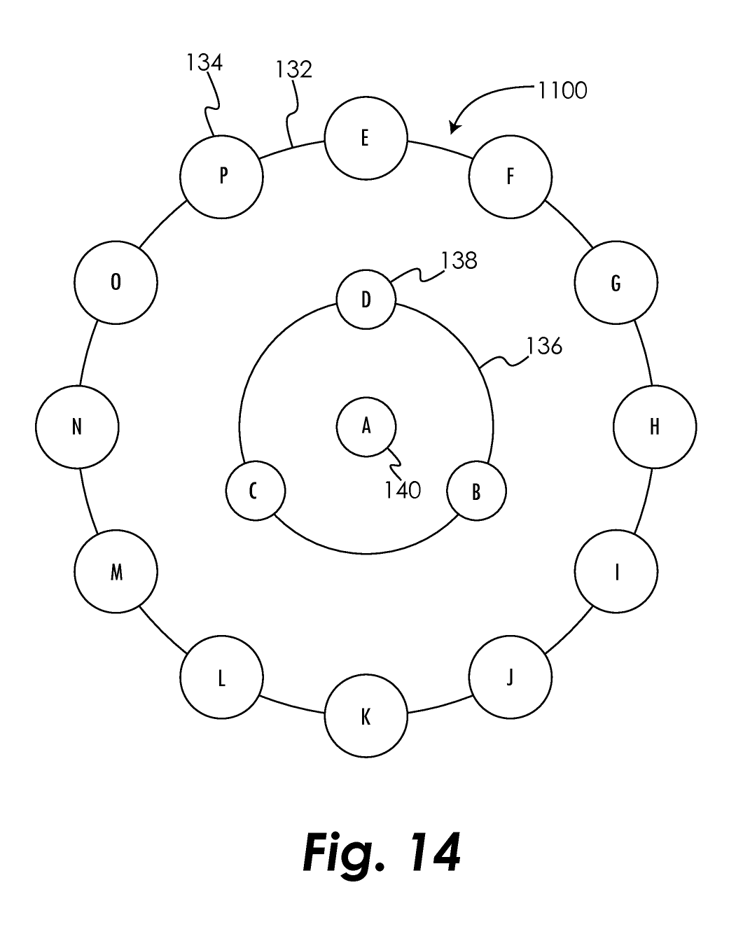

In addition to focusing priority on a single task circle 102 as shown in FIG. 12, entire subsets of task circles 130 may be given a higher priority than other subsets of task circles 102. FIG. 13 shows a configuration in which two levels of priority are displayed. The outer shape 132 comprises task circles 134 which have a lower priority, and the inner shape 136 comprises task circles 138 which have a higher priority. When the user clicks on a task circle, such as task circle 140, within the inner shape 136, that task circle 140 is moved to the center of the display as shown in FIG. 14, with the inner shape 136 being reconfigured to display the remaining three task circles 138. Likewise, if the user later clicks on the task circle 140 located in the center of the display of FIG. 14, that task circle 140 will be moved back to the inner shape 136.

In addition to clicking on the individual task circles 102 to trigger the focusing function, the user may drag the task circles 102 to the center using a mouse or other graphical manipulation device for focusing or to an outer layer or shape to remove focus. This drag function may also be used to adjust the relative priority of a task by dragging it to a more inner or outer layer in the display. In addition, the user may drag a task circle 102 from one ringed layer or shape to a space between two ringed layers or shapes, whereby the system will create a new ringed layer and assign the task to the newly created layer. The newly created layer will be assigned a priority that is between its two nearest neighbors.

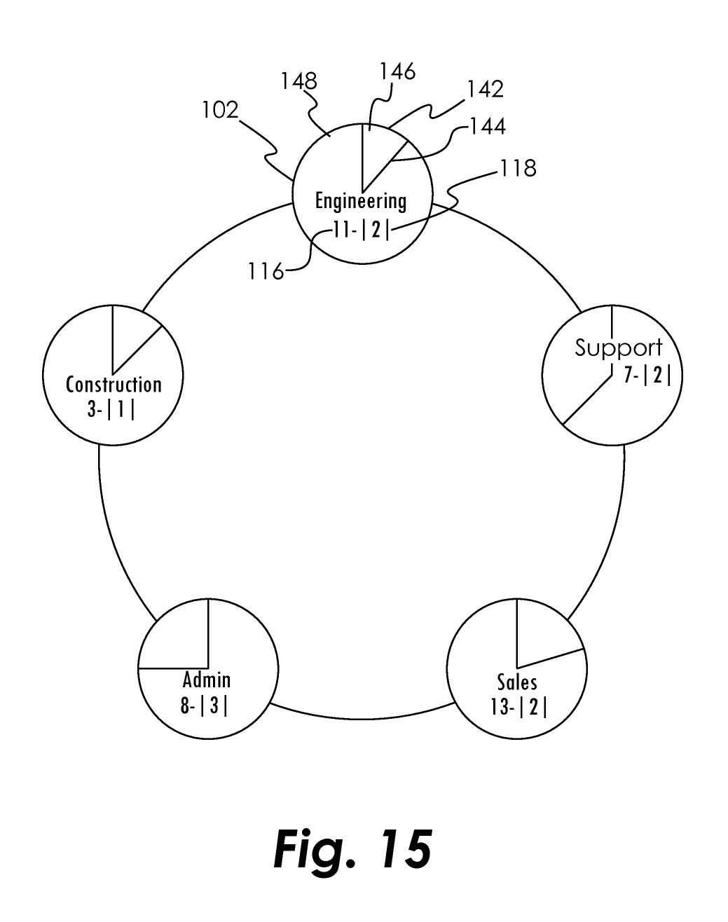

Each individual task circle 102 may also be labeled in the dynamic view to indicate any nested tasks and levels of abstraction within that task circle 102. FIG. 15 shows one embodiment whereby the individual task circles 102 in the dynamic view include a task quantity indicator 116 and an abstraction quantity indicator 118 similar to those used in the static mode display discussed above. For example, the task circle 102 labeled as “Engineering” in FIG. 11 comprises eleven nested tasks distributed across two nested levels of abstraction. In certain embodiments, a percent complete indicator 144 may also be displayed within the task circles 102 (in either the static mode or the dynamic mode). As shown in FIG. 15, the percent complete indicator 144 may optionally comprise a “pie chart” division, with the “complete” portion 146 being shaded in a first color and the remaining portion 148 shaded in a second color.

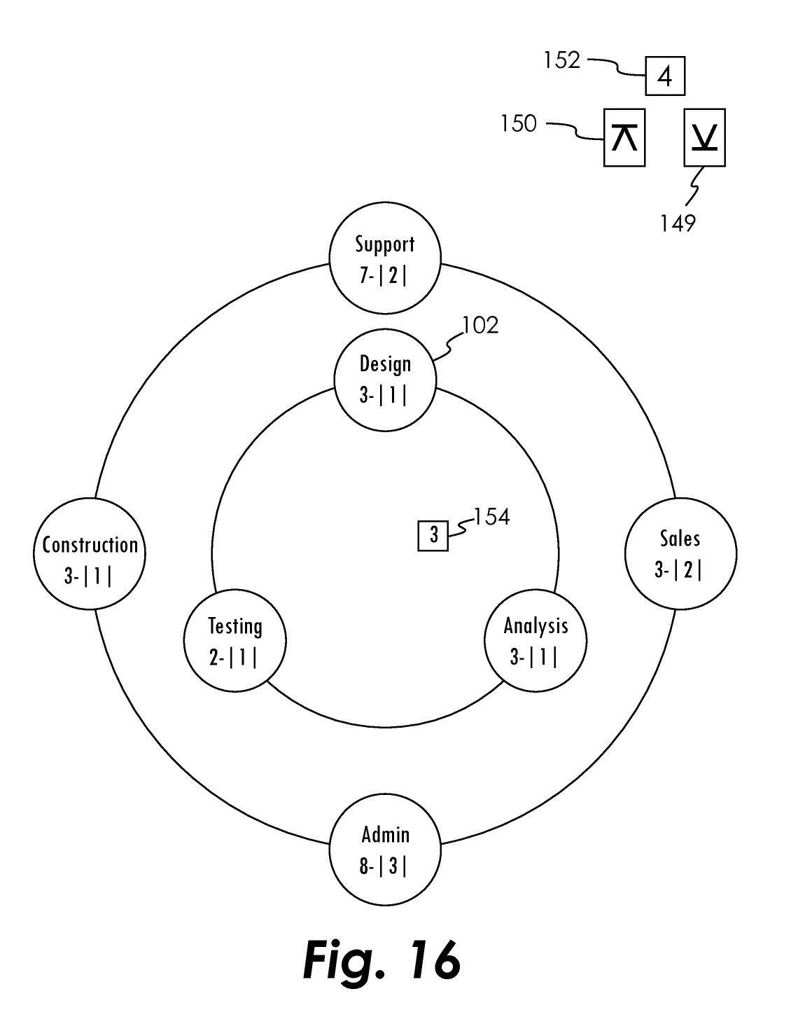

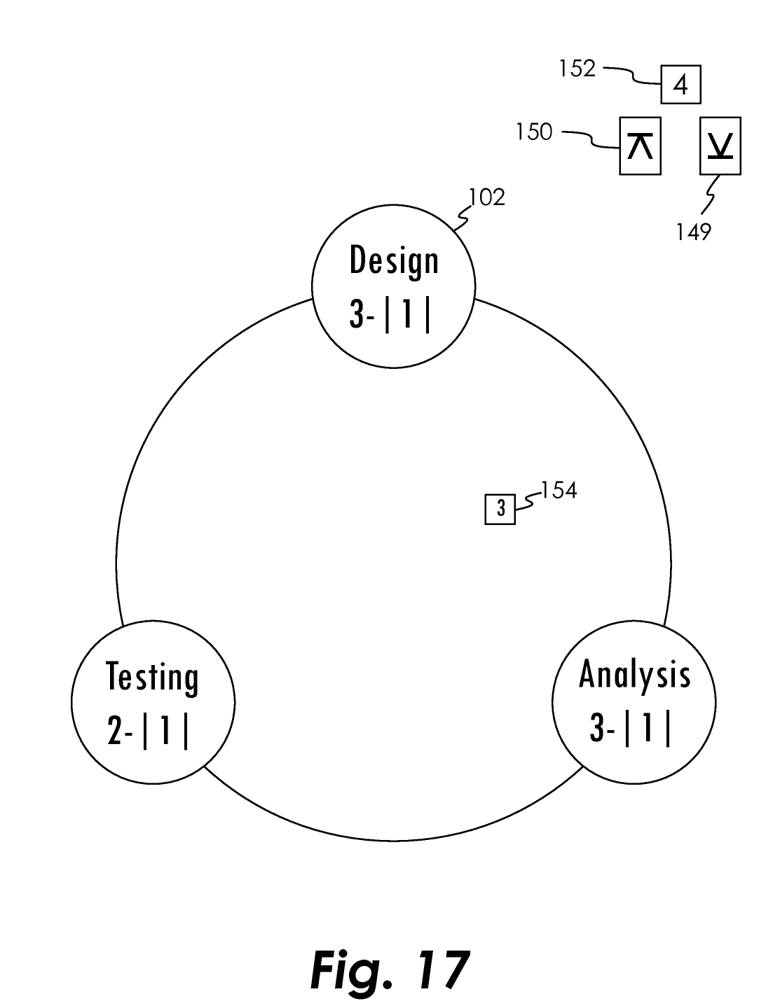

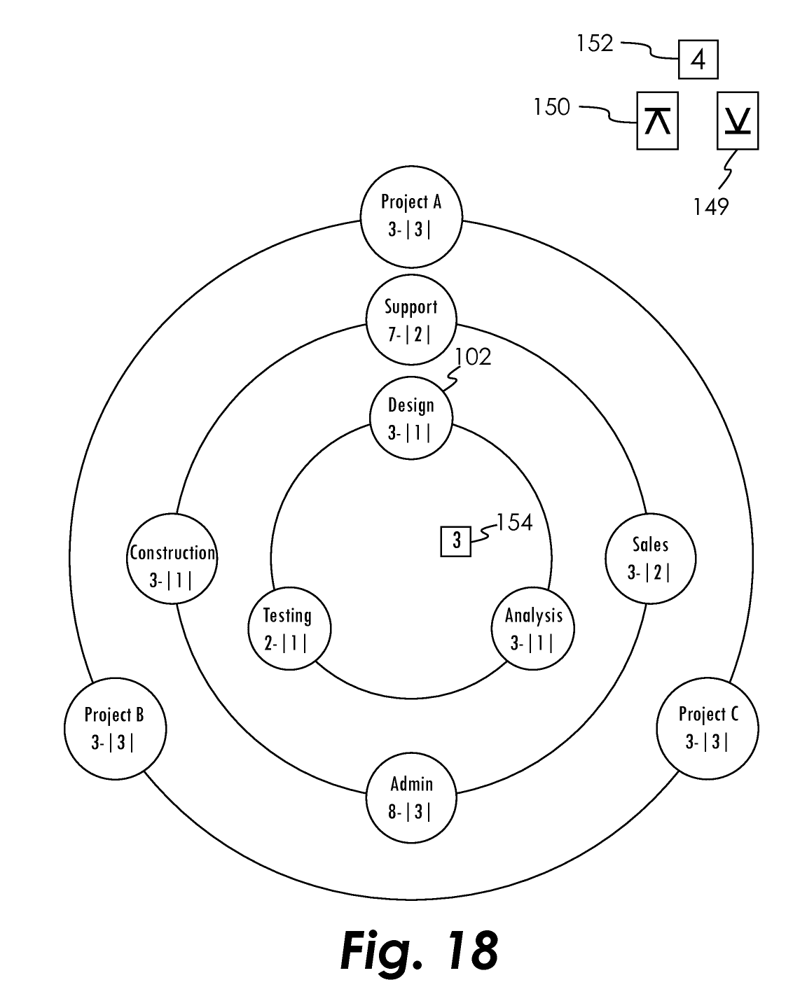

In certain embodiments, icons or other graphics may be provided to allow the user to adjust the number of displayed outer or inner layers. As shown in FIG. 16, icons 149 and 150 are provided to allow the user to respectively increase or decrease the displayed layers. For example, if the user clicks the icon 149 in FIG. 16, the system will remove the outermost layer, resulting in the display of FIG. 17. If the user had instead clicked the icon 150 in FIG. 16, the system will add an additional outside ring or layer, resulting in the display of FIG. 18. The system may also provide an indicator 152 for indicating the total number of layers available for display. It shall be understood that the indicator 152 may also be configured to display the number of displayed and/or undisplayed layers in addition to the total number of available layers. In certain embodiments, the indicator 152 may be used to indicate the amount of undisplayed outer layers, with indicator 154 being used to display the amount of undisplayed inner layers.

In certain embodiments, the system will maintain the number of displayed layers in a “rolling” fashion when the user clicks the icons 149 or 150. For example, the system may be configured such that when the user clicks the icon 150, the system will display the next available outer ring or layer and will also remove the innermost displayed layer so the total amount of currently displayed layers remains equal. Conversely, when the user clicks the icon 149, the system will display the next available inner ring or layer and will also remove the outermost displayed layer. This allows the user to set the total number of displayed layers to a certain number based on available screen size and resolution once, and then navigate inward and outward through the layers at will while still maximizing the amount of displayed layers that will comfortably fit on the screen.

In still further embodiments, the system is able to automatically manage the size of the task circles 102 and the font of the labels contained therein as items are added to a given layer. For example, as the number of items within a layer increases and the task circles 102 become increasingly crowded, the system will reduce the size of the task circles 102 and the font of the text labels. When the number of task circles 102 reaches a threshold level, the system may also remove the displayed label text and display only a designation number or other minimal label along with a “magnifier” icon which the user can click to view the expanded label text.

The interface of the present disclosure may also be subject to a permission hierarchy which provides varying levels of access depending on the identity of the user. For example, certain users will be allowed to view the details and relative priorities of various tasks, but not allowed to change the structure or content of the assigned tasks in either the static or dynamic mode. This would normally be the case for a lower level employee. Higher level employees, such as managers or executives, are able to use the static or dynamic mode to view the various projects being handled within an organization and make any necessary changes in the assignment, relative priority, and addition or deletion of tasks.

The disclosed interface may also be configured to provide historical tracking data with regard to any task or entity. For example, upon selecting an appropriate icon or menu, a list of all changes made to a task priority, sub-task hierarchy, or percent complete may be displayed for the user. In further embodiments, the system will automatically send a notification, such as an email message, to the person responsible when a new task is added or when a change is made to an existing task relationship, priority level, completion requirement, or other pertinent associated task variable.

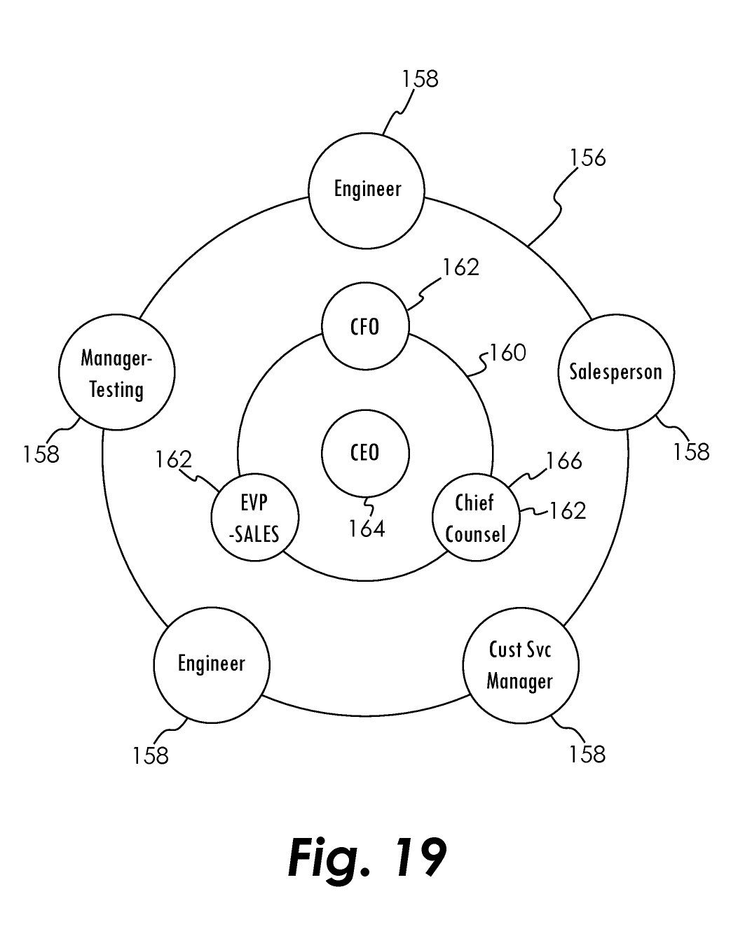

In addition to tasks within a project, the interface of the present disclosure may be used to display and organize other types of structural relationships. For example, the interface may be used to convey the relationship of individuals in an organization as shown in FIG. 19. In this embodiment, the outer shape 156 comprises circles 158 which correspond to lower level employees such as engineers, salespersons, and line managers. The inner shape 160 comprises circles 162 representing higher level employees such as the chief financial officer, chief counsel, and executive vice president of sales. The highest level position, the chief executive officer in this case, is represented by circle 164 and located in the center. Again, the circles 158,162, or 164 for a given position can be labeled to include a number corresponding to the number of employees that report to the person in that position. For example, by clicking on the circle 162 which corresponds to the Chief Counsel, a new shape will be displayed in the static mode which corresponds to the people who report to the person represented by that circle. In other embodiments, clicking on a circle 162 will bring up a list of tasks that are assigned to the person represented by that circle, along with other details such as projected completion dates or costs.

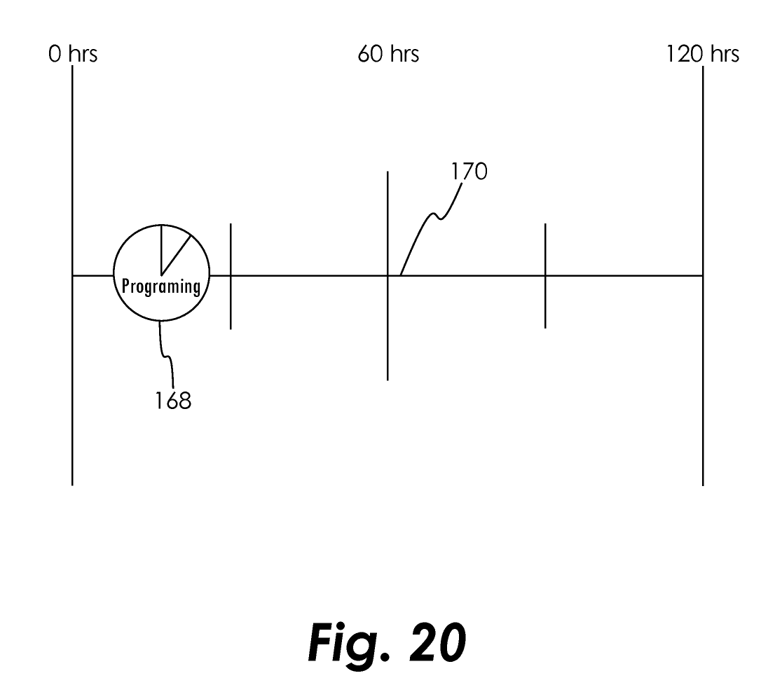

FIG. 20 shows another embodiment which shows the percent completion of a task represented by a task circle 168 along a timeline 170. This may be used to provide yet another visual reference to indicate percent complete for a task. The system may be optionally configured to trigger the timeline view of FIG. 20 when a user double clicks or otherwise selects a task circle in either the static or dynamic view.

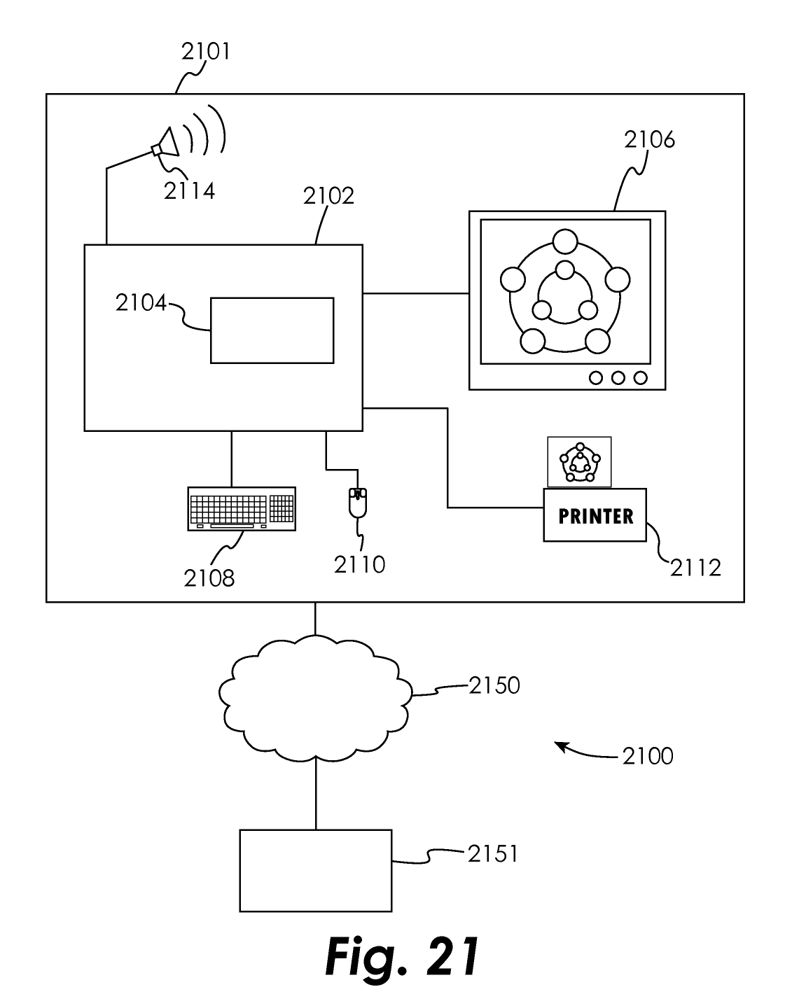

FIG. 21, shows, in schematic form, one embodiment of a project management system 2100 according to the present disclosure. The system 2100 may include a first subsystem 2101 including a processing device 2102, a data storage device 2104, a display 2106, user input devices such as keyboard 2108 and mouse 2110, a printer device 2112 and one or more speakers 2114. These devices are operatively coupled to allow the input of project data or other information into the processing device 2102 so that the visual representations of the various tasks or relationships may be displayed, printed or manipulated by users.

The processing device 2102 may be implemented on a personal computer, a workstation computer, a laptop computer, a palmtop computer, a wireless terminal having computing capabilities (such as a cell phone having a Windows CE or Palm operating system), or the like. It will be apparent to those of ordinary skill in the art that other computer system architectures may also be employed.

In general, such a processing device 2102, when implemented using a computer, comprises a bus for communicating information, a processor coupled with the bus for processing information, a main memory coupled to the bus for storing information and instructions for the processor, a read-only memory coupled to the bus for storing static information and instructions for the processor. The display 2106 is coupled to the bus for displaying information for a computer user and the input devices 2108, 2110 are coupled to the bus for communicating information and command selections to the processor. A mass storage interface for communicating with data storage device 2104 containing digital information may also be included in processing device 2102 as well as a network interface for communicating with a network.

The processor may be any of a wide variety of general purpose processors or microprocessors such as the PENTIUM microprocessor manufactured by Intel Corporation, a POWER PC manufactured by IBM Corporation, a SPARC processor manufactured by Sun Corporation, or the like. It will be apparent to those of ordinary skill in the art, however, that other varieties of processors may also be used in a particular computer system. Display 2106 may be a liquid crystal device (LCD), a cathode ray tube (CRT), a plasma monitor, a holographic display, or other suitable display device. The mass storage interface may allow the processor access to the digital information in the data storage devices via the bus. The mass storage interface may be a universal serial bus (USB) interface, an integrated drive electronics (IDE) interface, a serial advanced technology attachment (SATA) interface or the like, coupled to the bus for transferring information and instructions. The data storage device 2104 may be a conventional hard disk drive, a floppy disk drive, a flash device (such as a jump drive or SD card), an optical drive such as a compact disc (CD) drive, digital versatile disc (DVD) drive, HD DVD drive, BLUE-RAY DVD drive, or another magnetic, solid state, or optical data storage device, along with the associated medium (a floppy disk, a CD-ROM, a DVD, etc.)

In general, the processor retrieves processing instructions and data from the data storage device 2104 using the mass storage interface and downloads this information into random access memory for execution. The processor then executes an instruction stream from random access memory or read-only memory. Command selections and information that is input at input devices 2108, 2110 are used to direct the flow of instructions executed by the processor. Equivalent input devices 2110 may also be a pointing device such as a conventional trackball device. The results of this processing execution are then displayed on display device 2106.

The processing device 2102 is configured to generate an output for viewing on the display 2106 and/or for driving the printer 2112 to print a hardcopy. Preferably, the video output to display 2106 is also a graphical user interface, allowing the user to interact with the displayed information.

The system 2100 may optionally include one or more subsystems 2151 substantially similar to subsystem 2101 and communicating with subsystem 2101 via a network 2150, such as a LAN, WAN or the internet. Subsystems 2101 and 2151 may be configured to act as a web server, a client or both and will preferably be browser enabled. Thus with system 2100, remote collaboration and analysis may occur between users.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

What is claimed is:

1. A method for providing a visualization of task relationships within a project, comprising:
providing a first plurality of equally spaced shapes in the formation of a first ring on a display, each one of said first plurality of shapes representing a first plurality of corresponding tasks within said project; and
concurrently providing a second plurality of equally spaced shapes in the formation of a second ring on the display, each one of said second plurality of shapes representing a second plurality of corresponding tasks within said project;
wherein the relative priority of said first plurality of corresponding tasks is higher than the relative priority of said second plurality of corresponding tasks; and
wherein the first ring has a first diameter which is smaller than a second diameter of the second ring.

2. The method of claim 1, wherein each one of said first ring and said second ring are selected from a circle and a polygon.

3. A system for visualizing task relationships within a project, comprising:
a user input device;
a processing device operatively coupled to said user input device; and
a display operatively coupled to said processing device;
wherein:
said processing device executes computer readable code to create a first visual representation of said task relationships for output on said display;
wherein:
said first visual representation is generated according to a method comprising the steps of:
providing a first plurality of equally spaced shapes in the formation of a first ring on a display, each one of said first plurality of shapes representing a first plurality of corresponding tasks within said project; and
concurrently providing a second plurality of equally spaced shapes in the formation of a second ring on the display, each one of said second plurality of shapes representing a second plurality of corresponding tasks within said project;
wherein:
the relative priority of said first plurality of corresponding tasks is higher than said the relative priority of said second plurality of corresponding tasks; and
wherein:
the first ring has a first diameter which is smaller than a second diameter of the second ring.

4. The system of claim 1, wherein each one of said first ring and said second ring are selected from a circle and a polygon.

5. The system of claim 3, wherein the system is configured to allow the user to move a first one of said first plurality of equally spaced shapes corresponding to a first task from said first ring to said second ring using said user input device.

6. The system of claim 5, wherein the relative spacing of said second plurality of equally spaced shapes is automatically decreased when said first one of said first plurality of shapes is moved to said second ring.

7. The system of claim 5, wherein said processor executes computer readable code to send an electronic notification to a user responsible for said first task when said first task is moved from said first ring to said second ring on said display.

8. The system of claim 3,
wherein said processor executes computer readable code to provide a third plurality of equally spaced shapes in the formation of a third ring on the display in response to input from the user input device, each one of said third plurality of shapes representing a third plurality of corresponding tasks within said project;
wherein the relative priority of said third plurality of corresponding tasks is lower than the relative priority of said second plurality of corresponding tasks; and
wherein the third ring has a third diameter which is larger than the second diameter of the second ring.

9. The system of claim 8,
wherein said first plurality of corresponding shapes is removed from said display when said third plurality of corresponding shapes is displayed.

10. The system of claim 3,
wherein said processor executes computer readable code to provide a third plurality of equally spaced shapes in the formation of a third ring on the display in response to input from the user input device, each one of said third plurality of shapes representing a third plurality of corresponding tasks within said project;
wherein the relative priority of said third plurality of corresponding tasks is higher than the relative priority of said first plurality of corresponding tasks; and
wherein the third ring has a third diameter which is smaller than the first diameter of the first ring.

11. The system of claim 10,
wherein said second plurality of corresponding shapes is removed from said display when said third plurality of corresponding shapes is displayed.

12. The system of claim 3, wherein a first one of said first plurality of shapes is displayed in the twelve o'clock position.

13. The system of claim 12, wherein a first one of said second plurality of shapes is displayed in the twelve o'clock position.

14. A device comprising a computer readable medium, said computer readable medium containing computer executable code for generating a visual representation of task relationships within a project;
wherein:
said computer executable code is configured to generate said visual representation according to a method comprising the steps of:
providing a first plurality of equally spaced shapes in the formation of a first ring on a display, each one of said first plurality of shapes representing a first plurality of corresponding tasks within said project; and
concurrently providing a second plurality of equally spaced shapes in the formation of a second ring on the display, each one of said second plurality of shapes representing a second plurality of corresponding tasks within said project;
wherein:
the relative priority of said first plurality of corresponding tasks is higher than said the relative priority of said second plurality of corresponding tasks; and
wherein:
the first ring has a first diameter which is smaller than a second diameter of the second ring.

15. The device of claim 14, wherein each one of said first ring and said second ring are selected from a circle and a polygon.

16. The device of claim 14, wherein the device is configured to allow the user to move a first one of said first plurality of equally spaced shapes corresponding to a first task from said first ring to said second ring using said user input device.

17. The device of claim 16, wherein the relative spacing of said second plurality of equally spaced shapes is automatically decreased when said first one of said first plurality of shapes is moved to said second ring.

18. The device of claim 16, wherein said processor executes computer readable code to send an electronic notification to a user responsible for said first task when said first task is moved from said first ring to said second ring on said display.

19. The device of claim 14,
wherein said processor executes computer readable code to provide a third plurality of equally spaced shapes in the formation of a third ring on the display in response to input from the user input device, each one of said third plurality of shapes representing a third plurality of corresponding tasks within said project;
wherein the relative priority of said third plurality of corresponding tasks is lower than the relative priority of said second plurality of corresponding tasks; and
wherein the third ring has a third diameter which is larger than the second diameter of the second ring.

20. The device of claim 19,
wherein said first plurality of corresponding shapes is removed from said display when said third plurality of corresponding shapes is displayed.

21. The device of claim 14,
wherein said processor executes computer readable code to provide a third plurality of equally spaced shapes in the formation of a third ring on the display in response to input from the user input device, each one of said third plurality of shapes representing a third plurality of corresponding tasks within said project;
wherein the relative priority of said third plurality of corresponding tasks is higher than the relative priority of said first plurality of corresponding tasks; and
wherein the third ring has a third diameter which is smaller than the first diameter of the first ring.

22. The device of claim 21,
wherein said second plurality of corresponding shapes is removed from said display when said third plurality of corresponding shapes is displayed.

23. A system for visualizing task relationships within a project, comprising:
a user input device;
a processing device operatively coupled to said user input device; and
a display operatively coupled to said processing device;
wherein:
said processing device executes computer readable code to create a first visual representation of said task relationships for output on said display;
wherein:
said first visual representation is generated according to a method comprising the steps of:
providing a first plurality of equally spaced shapes in the formation of a first ring on a display, each one of said first plurality of shapes representing a first plurality of corresponding parent tasks within said project;
selecting a first one of said first plurality of equally spaced shapes corresponding to a first one of said parent tasks; and
providing a second plurality of equally spaced shapes in the formation of a second ring on the display, each one of said second plurality of equally spaced shapes representing a second plurality of corresponding sub-tasks within said first one of said parent tasks.

24. The device of claim 23, wherein each one of said first ring and said second ring are selected from a circle and a polygon.
